(19) United States
(12) Patent Application Publication
(10) Pub. No.: US 2009/0050331 A1
(43) Pub. Date: Feb. 26, 2009

(54) Method For Enhanced Recovery Of Oil From Oil Reservoirs

(76) Inventors: Walter Mahler, Wilmington, DE (US); Scott Christopher Jackson, Wilmington, DE (US); Berardino D'achilles, Ardmore, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/843,857

(22) Filed: Aug. 23, 2007

(51) Int. Cl. E21B 43/16; C09K 8/58

(52) U.S. Cl. 166/372; 507/204

(57) ABSTRACT

The present invention provides a method for enhancing the recovery of oil from a subterranean reservoir using waterflooding, wherein the flooding fluid used in the waterflooding process comprises water and comminuted feathers. The use of comminuted feathers is expected to increase the recovery of oil by improving sweep efficiency.

### FIELD OF THE INVENTION

The present invention relates to a process for enhancing the recovery of crude oil from oil reservoirs using a flooding fluid comprising water and comminuted feathers.

### BACKGROUND OF THE INVENTION

In the recovery of oil from oil-bearing reservoirs, it is typically possible to recover only minor portions of the original oil in place by primary recovery methods which utilize only the natural forces present in the reservoir. Thus a variety of supplemental recovery techniques have been used in order to increase oil recovery. A commonly used secondary technique is waterflooding which involves the injection of water into the oil reservoir. As the water moves through the reservoir, it acts to displace oil therein to one or more production wells through which the oil is recovered.

One problem that can be encountered with waterflooding operations is the relatively poor sweep efficiency of the water, i.e., the water can channel through certain portions of the reservoir as it travels from the injection well(s) to the production well(s), thereby bypassing other portions of the reservoir. Poor sweep efficiency may be due, for example, to differences in the mobility of the water versus that of the oil, and permeability variations within the reservoir which encourage flow through some portions of the reservoir and not others.

Various enhanced oil recovery techniques have been used to improve sweep efficiency. One such technique involves increasing the viscosity of the water using non-biodegradable thickening agents such as polyvinyl aromatic sulfonates as described in U.S. Pat. No. 3,085,063. The present invention provides a method for improving sweep efficiency through the use of cost-effective, biodegradable materials that exhibit shear-thinning properties and thus exhibit lower viscosity during injection and increased viscosity in the oil reservoir.

### SUMMARY OF THE INVENTION

The present invention relates to the recovery of oil from a subterranean reservoir using waterflooding. In one embodiment, the present invention provides a method for enhancing the recovery of oil from a reservoir, comprising:
a) introducing an aqueous flooding fluid into the reservoir, wherein at least one portion of said flooding fluid comprises comminuted feathers; and
b) displacing oil in the reservoir with said flooding fluid.

The flooding fluid displaces the oil into one or more production wells, whereby the oil is recoverable.

In another embodiment, the present invention provides a method for making an aqueous flooding fluid for use in waterflooding, comprising:
a) comminuting feathers to achieve a particle size distribution of about 0.1 to about 100 microns; and
b) adding said comminuted feathers to at least one portion of water used in waterflooding.

In yet another embodiment, the present invention provides a flooding fluid for use in water flooding operations.

### BRIEF DESCRIPTION OF THE DRAWINGS

FIG. 1 shows particle size distribution data of comminuted feathers in water.

FIG. 2 shows the viscosity of comminuted goose feathers in water as a function of shear rate.

### DETAILED DESCRIPTION

The present invention relates to the recovery of oil from a subterranean reservoir using waterflooding. Waterflooding is a technique that is commonly used for secondary oil recovery from oil reservoirs. According to this technique, water is injected through one or more wells into the reservoir, and as the water moves through the reservoir, it acts to displace oil therein to one or more production wells through which the oil is recovered. According to the present invention, the efficacy of waterflooding is improved through the use of comminuted feathers. Thus, in one embodiment, the present invention provides a flooding fluid for use in waterflooding operations comprising water, wherein at least one portion of said water comprises comminuted feathers. In another embodiment, the present invention provides a method for enhancing the recovery of oil from a reservoir by waterflooding, comprising:
a) introducing an aqueous flooding fluid into the reservoir, wherein at least one portion of said flooding fluid comprises comminuted feathers; and
b) displacing oil in the reservoir with said flooding fluid.

The flooding fluid can displace the oil in (b) into one or more production wells whereby the oil is recoverable. Production wells are wells through which oil is withdrawn from a reservoir. An oil reservoir or oil formation is a subsurface body of rock having sufficient porosity and permeability to store and transmit oil.

The present invention provides an advantage to existing technology in that the comminuted feathers are biodegradable, and thus the flooding fluid can be safely released into the environment surrounding the oil recovery operation if necessary, or as an accidental release. In addition, flooding fluid comprising comminuted feathers exhibit shear-thinning properties, such that the dispersion exhibits low viscosity at high shear rates and increased viscosity at low shear rates. As used herein, “shear thinning” refers to the reduction of viscosity of a liquid (such as that portion of the flooding fluid comprising comminuted feathers) under shear stress. “Viscosity” refers to the resistance of a liquid (such as water or oil) to flow.

The flooding fluid useful for waterflooding according to the present invention comprises water and comminuted feathers. “Water” can be supplied from any suitable source, and can include, for example, sea water, brine, production water, water recovered from an underground aquifer, including those aquifers in contact with the oil, or surface water from a stream, river, pond or lake. As is known in the art, it may be necessary to remove particulates from the water prior to injection into the one or more wells.

“Comminuted feathers” are feathers that have been reduced in size. Comminuted feathers can be produced by techniques such as pulverizing, grinding, shearing, shredding, milling, crushing, breaking or combinations thereof. Any technique can be utilized provided that, after comminution, the feathers possess the desired particle size distribution and exhibit the appropriate shear-thinning properties in the waterflooding process such that oil recovery is enhanced. Equipment that can be used for comminution include ball mills, rolling mills, pulverizing equipment or grinding equipment. In one embodiment, the feathers are comminuted in water at a concentration of about 0.1% to about 20%; if larger feather particles remain after comminution, it may be necessary to remove these larger particles, for example by allowing them to settle out and separating the liquid layer comprising the feathers having the desired size distribution by an appropriate method, such as settling and decantation, centrifugation or filtering.

Feathers can be obtained from any suitable source. In one embodiment, feathers are obtained from bird species selected from the group consisting of chicken, duck, turkey, goose and combinations thereof. In another embodiment, feathers can be obtained from bird species selected from the group consisting of chicken, goose and combinations thereof.

The flooding fluid useful for the waterflooding process of the invention comprises water, wherein at least a portion said water comprises comminuted feathers. Thus, in one embodiment, comminuted feathers are added to a volume of water and injected into the well(s), followed by the injection of additional water. This process can be repeated one or more times if necessary. At the injection well(s), which is under high pressure and high shear, the relative viscosity of the at least one portion of the flooding fluid comprising comminuted feathers is low, whereas as the at least one portion of the flooding fluid flows into the reservoir, the shear decreases and the relative viscosity increases. The comminuted feathers can also be added to the entire volume of flooding fluid, as long as the backpressure at the injection well(s) does not become too high. As is known to those skilled in the art of oil recovery, the bottom well pressure of the injector can not exceed the strength of the rock formation, otherwise formation damage will occur at a given flow rate. Adjustments can be made by reducing the flow of the injection water, adding water to decrease viscosity, or by adding water mixed with comminuted feathers to increase viscosity in order to improve the efficacy of oil recovery.

The comminuted feathers can be added as a solid, for example a powder, to the at least one portion of the flooding fluid, or can be added as a liquid dispersion, for example in water. The concentration of the comminuted feathers in the at least one portion of the flooding fluid can be in the range of about 0.007% to about 1% (weight of comminuted feathers/total volume of the at least one portion of flooding fluid comprising said comminuted feathers). In another embodiment, the concentration is in the range of about 0.01% to about 0.05% (weight/volume).

In one embodiment, the comminuted feathers are added to flooding fluid in order to increase the viscosity of at least one portion of the water in the flooding fluid, thereby improving the displacement of oil to the production well(s). To achieve optimal efficiency in waterflooding operations, it is desirable that the mobility of the water be less than the mobility of the oil. The “mobility” is the ratio of the permeability to the flow of a liquid to the dynamic viscosity of said liquid (Boatright, KE, 2002, Basic Petroleum Engineering Practices 9.6, see also integrated Petroleum Management—A Team Approach, (A. Sattar and G Thakurm, PennWell Books, Tulsa, Okla., 1994)). The oil mobility is calculated by the formula kₒ/μₒ, where kₒ is the oil permeability and μₒ is the oil dynamic viscosity. Similarly, the water mobility is calculated by k_{w}/μ_{w}, where k_{w} is the water permeability and μ_{w} is the water dynamic viscosity. In typical water flooding operations the water mobility is greater than the oil mobility, thus the water will tend to channel or finger through the oil. When comminuted feathers are added to the at least one portion of the flooding fluid as described by embodiments of the present invention, the addition of the comminuted feathers increases the viscosity of the at least one portion of the water, thereby reducing the effective water mobility to a value lower than the oil mobility. Thus, the oil is more likely to be driven towards the production well(s).

In one embodiment, the viscosity of the at least one portion of the flooding fluid comprising comminuted feathers is greater than about 2 centipoise at low shear rates, wherein low shear rates are less than about 3 sec⁻¹. In another embodiment, the viscosity of the at least one portion of the flooding fluid comprising comminuted feathers is less than about 1 centipoise at high shear rates, wherein high shear rates are greater than about 50 sec⁻¹.

In a stratified oil-bearing formation the permeability of different geological oil-bearing layers may differ, which has as result that injected water will reach the production well initially through the most permeable layer, before a substantial amount of the oil of the other, less permeable, layers is retrieved. This breakthrough of injection water is problematic for oil recovery, as the water/oil ratio retrieved from the production well will increase and become more unfavorable during the lifetime of the oil field. The addition of comminuted feathers to at least one portion of the flooding fluid is expected to result in plugging of the more permeable zones in a reservoir, thus preventing fingering of flooding fluid through these more permeable zones of the oil bearing strata and improving sweep efficiency.

The particle size of the comminuted feathers necessary to achieve good sweep efficiency will depend on the reservoir in which the feathers are being used. Reservoirs can be composed of different geological formations, for example sand, limestone, or chalk, and can comprise pores of varying sizes. Typically the particle size useful for oil recovery will be in the range of about 0.1 to about 100 microns. In another embodiment, the particle size will be in the range of about 0.5 to about 50 microns. Particle size can be determined using particle size analyzers as available from Beckman Coulter (Fullerton, Calif.), wherein particle size distribution is determined by laser diffraction or by measuring resistance changes as particles in an electrolyte solution flow past a sensor.

Additional materials can optionally be added as thickening agents or surface active agents to enhance the sweep efficiency of the flooding fluid and/or reduce water mobility. These materials include at least one of the group consisting of hay, sugar cane fibers, cotton seed hull, textile fibers, shredded paper, bentonite, rubber pulp, wood shavings and nut hulls, provided that these materials together with the comminuted feathers provided the desired viscosity, concentration and/or particle size distribution. In addition, thickeners, such as polyacrylic amide, carboxymethylcellulose, polysaccharide, polyvinyl alcohol, polyvinyl pyrrolidone, polyacyrlic, and polystyrene sulfonates, and ethylene oxide polymers, as described in U.S. Pat. No. 3,757,863, column 2, line 33 to line 54; and methyl cellulose, starch, guar gum, gum tragacanth, sodium alginate, and gum arabic, as described in U.S. Pat. No. 3,421,582, column 2, line 33 to line 45. Each of the thickeners can be used alone, or in combination with one or more other thickeners as described above. Surfactants, such as acid salts of amido-acids as described in U.S. Pat. No. 2,802,785, column 2, line 11 to column 4, line 43 can also optionally be added. Surfactants and thickeners can also be used in combination. The use of comminuted feathers according to the present invention is advantageous in that the feathers are biodegradable and do not present environmental toxicity problems. Bird feathers are composed of 9-keratin, and can be hydrolyzed by keratinolytic organisms such as fungi and bacteria of the genera Bacillus and Streptomyces to yield oligopeptides. Thus, in one embodiment, the additional materials that are added to flooding fluids of the invention are preferably also biodegradable, such as starch, guar gum, sodium alginate, gum arabic and methyl cellulose.

In one embodiment, the present invention provides a method for making an aqueous flooding fluid for use in waterflooding, comprising:
a) comminuting feathers as described above to achieve a particle size distribution of about 0.1 to about 100 microns; and
b) adding said comminuted feathers to at least one portion of water used in waterflooding.

The flooding fluid can be recovered as it exits the production well(s) and at least one portion of said flooding fluid can be reused, i.e., injected, into the reservoir. Prior to reinjection into the reservoir, additional comminuted feathers can be added to at least one portion of the recovered flooding fluid. Additional comminuted feathers can be added at a concentration of about 0.007% to about 1% (weight of feathers/volume of the at least one portion of flooding fluid). Alternatively, at least one portion of the flooding fluid exiting the production well(s) can be disposed of, for example by disposal at sea, in a disposal well, or in a wastewater pond.

### EXAMPLES

The present invention is further defined in the following Examples. It should be understood that these Examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

### Example 1

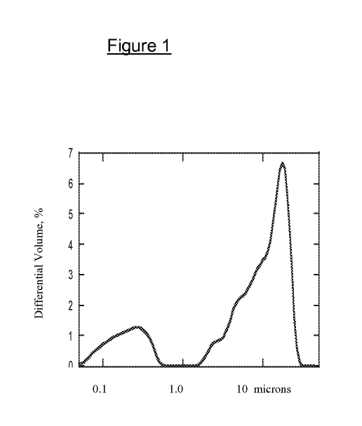

Goose feathers (20 grams) were added to 500 grams of water in a blender and agitated for 20 minutes. The resulting mixture was further mixed using a Silverton L4RT Lab Mixer. An opaque suspension was formed. This opaque suspension was allowed to settle for a day producing a translucent supernatant and solids. The supernatant (about 250 milliliters) was separated from the suspension by decantation and contained 0.015% solids. The particle size distribution (PSD) of the supernatant was measured using a Beckman Coulter LS13320. Before measuring the PSD, the supernatant was sonicated in an ultrasonic bath for 1 minute. Results of the particle size distribution determination are shown in FIG. 1.

### Example 2

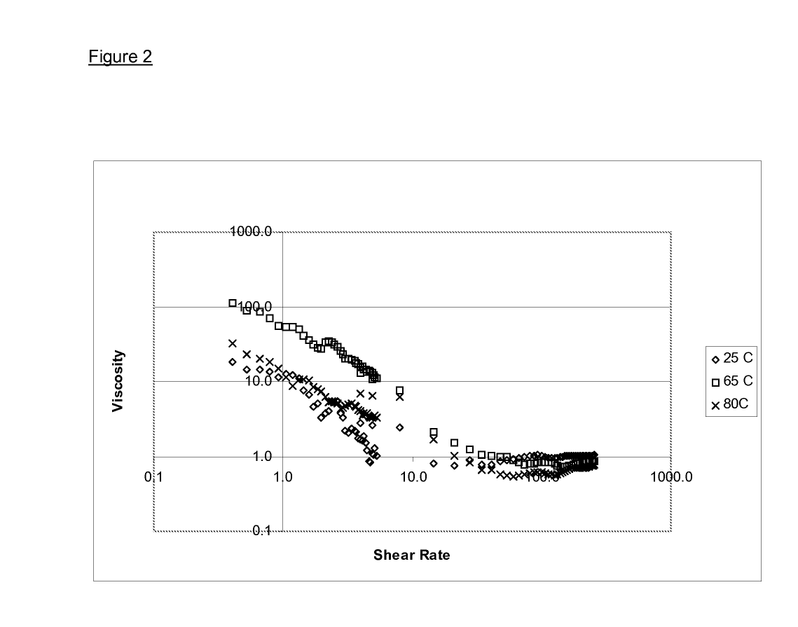

The viscosity of the supernatant from Example 1 was measured as a function of shear rate using a Brookfield DV-II+ Pro instrument using a SC4-18 spindle with water jacketed cup and remote temperature detection probe (Brookfield Engineering Laboratories, Inc., Middleboro, Mass.). The instrument was controlled using Rheocal software v2.7. The shear rate was varied from 0.4 sec⁻¹ to 250 sec⁻¹ at 25, 65 and 80° C. The raw data was smoothed by doing a three point average, and the results are shown in FIG. 2.

1. A method for enhancing the recovery of oil from a reservoir, comprising:
a) introducing an aqueous flooding fluid into the reservoir, wherein at least one portion of said flooding fluid comprises comminuted feathers; and
b) displacing oil in the reservoir with said flooding fluid.

2. The method of claim 1, wherein the flooding fluid displaces the oil in (b) into one or more production wells whereby the oil is recoverable.

3. The method of claim 1, wherein said flooding fluid is recovered, and wherein at least one portion of said the recovered flooding fluid is reinjected into the reservoir.

4. The method of claim 3, wherein additional comminuted feathers are added to at least one portion of said flooding fluid prior to reinjection.

5. The method of claim 4, wherein said additional comminuted feathers are added at a concentration of about 0.007% to about 1% (weight of feathers/volume of the at least one portion of flooding fluid).

6. The method of claim 1, wherein said flooding fluid is disposed of.

7. The method of claim 6, wherein the flooding fluid is disposed of at sea, in a disposal well, or in a wastewater pond.

8. The method of claim 1, wherein said aqueous flooding fluid comprises sea water, brine, production water, water recovered from an underground aquifer, or surface water from a stream, river, pond or lake.

9. The method of claim 1, wherein said comminuted feathers comprise feathers from one or more bird species selected from the group consisting of chicken, turkey, duck and goose.

10. The method of claim 9, wherein said comminuted feathers comprise chicken, or goose feathers.

11. The method of claim 1, wherein the comminuted feathers are produced by pulverizing, grinding, shearing, shredding, milling, crushing, breaking or a combination thereof.

12. The method of claim 1, wherein the comminuted feathers increase the shear thinning properties of the flooding fluid.

13. The method of claim 1, wherein the at least one portion comprises comminuted feathers, and wherein said at least one portion comprising comminuted feathers exhibits a low viscosity during injection into the reservoir and a higher viscosity when flowing through the reservoir.

14. The method of claim 13, wherein the viscosity of the at least one portion of the flooding fluid comprising comminuted feathers is greater than about 2 centipoise at low shear rates, wherein low shear rates are less than about 3 sec⁻¹, and wherein the viscosity of the at least one portion of the flooding fluid comprising comminuted feathers is less than about 1 centipoise at high shear rates, wherein high shear rates are greater than about 50 sec⁻¹.

15. The method of claim 1, wherein the concentration of comminuted feathers in the at least one portion of the flooding fluid is in the range of about 0.007% to about 1% (weight of comminuted feathers/total volume of the at least one portion of flooding fluid comprising said comminuted feathers).

16. The method of claim 15, wherein the concentration of comminuted feathers in the at least one portion of the flooding fluid is in the range of about 0.01% to about 0.05% (weight of comminuted feathers/total volume of the at least one portion of flooding fluid comprising said comminuted feathers).

17. The method of claim 1 or claim 15, wherein the comminuted feathers have a particle size distribution of about 0.1 to about 100 microns.

18. The method of claim 17, wherein the comminuted feathers have a particle size distribution of about 0.5 to about 50 microns.

19. The method of claim 1, wherein the aqueous flooding fluid further comprises at least one of the group consisting of hay, sugar cane fibers, cotton seed hulls, textile fibers, shredded paper, bentonite, rubber pulp, wood shavings, nut hulls, polyacrylic amide, carboxymethylcellulose, polysaccharide, polyvinyl alcohol, polyvinyl pyrrolidone, polyacyrlic, polystyrene sulfonates, ethylene oxide polymers, methyl cellulose, starch, guar gum, gum tragacanth, sodium alginate, gum Arabic and surfactants.

20. The method of claim 19, wherein the aqueous flooding fluid further comprises starch, guar gum, sodium alginate, gum arabic or methyl cellulose.

21. The method of claim 1, wherein the sweep efficiency is improved.

22. The method of claim 1, wherein the water mobility decreases.

23. A method of making an aqueous flooding fluid for use in waterflooding, comprising:
a) comminuting feathers to achieve a particle size distribution of about 0.1 to about 100 microns; and
b) adding said comminuted feathers to at least one portion of water used in waterflooding.

24. The method of claim 23, wherein said comminuted feathers are added to at least one portion of the water being used in waterflooding as a solid or as a liquid dispersion.

25. The method of claim 24, wherein the liquid is water.

26. The method of claim 23, wherein the concentration of comminuted feathers in the at least one portion of water is about 0.007% to about 1%.

27. The method of claim 23, wherein said comminuted feathers are produced by pulverizing, grinding, shearing, shredding, milling, crushing, breaking or a combination thereof.

28. The method of claim 23, wherein said comminuted feathers comprise feathers from one or more bird species selected from the group consisting of chicken, turkey, duck and goose.

29. The method of claim 23, wherein said water is sea water, brine, production water, water recovered from an underground aquifer, or surface water from a stream, river, pond or lake.

30. An aqueous flooding fluid for enhanced oil recovery, wherein at least one portion of said flooding fluid comprises comminuted feathers.

31. The aqueous flooding fluid of claim 30, wherein said aqueous flooding fluid comprises production water, sea water, production water, water recovered from an underground aquifer, or surface water from a stream, river, pond or lake.

32. The aqueous flooding fluid of claim 30, wherein said comminuted feathers comprise feathers from one or more bird species selected from the group consisting of chicken, turkey, duck and goose.

33. The aqueous flooding fluid of claim 30, wherein the comminuted feathers are produced by pulverizing, grinding, shearing, shredding, milling, crushing, breaking or a combination thereof.

34. The aqueous flooding fluid of claim 30, wherein the at least one portion comprises comminuted feathers, and wherein said at least one portion comprising comminuted feathers exhibits a low viscosity during injection into the reservoir and a higher viscosity when flowing through the reservoir.

35. The aqueous flooding fluid of claim 34, wherein the viscosity of the at least one portion of the flooding fluid comprising comminuted feathers is greater than about 2 centipoise at low shear rates, wherein low shear rates are less than about 3 sec⁻¹, and wherein the viscosity of the at least one portion of the flooding fluid comprising comminuted feathers is less than about 1 centipoise at high shear rates, wherein high shear rates are greater than about 50 sec⁻¹.

36. The aqueous flooding fluid of claim 30, wherein the concentration of comminuted feathers in the at least one portion of the flooding fluid is in the range of about 0.007% to about 1% (weight of comminuted feathers/total volume of the at least one portion of flooding fluid comprising said comminuted feathers).

37. The aqueous flooding fluid of claim 36, wherein the concentration of comminuted feathers in the at least one portion of the flooding fluid is in the range of about 0.01% to about 0.05% (weight of comminuted feathers/total volume of the at least one portion of flooding fluid comprising said comminuted feathers).

38. The aqueous flooding fluid of claim 30, wherein the comminuted feathers have a particle size distribution of about 0.1 to about 100 microns.

39. The aqueous flooding fluid of claim 38, wherein the comminuted feathers have a particle size distribution of about 0.5 to about 50 microns.

40. The aqueous flooding fluid of claim 30, wherein the aqueous flooding fluid further comprises at least one of the group consisting of hay, sugar cane fibers, cotton seed hulls, textile fibers, shredded paper, bentonite, rubber pulp, wood shavings, nut hulls, polyacrylic amide, carboxymethylcellulose, polysaccharide, polyvinyl alcohol, polyvinyl pyrrolidone, polyacyrlic, polystyrene sulfonates, ethylene oxide polymers, methyl cellulose, starch, guar gum, gum tragacanth, sodium alginate, gum Arabic and surfactants.

41. The aqueous flooding fluid of claim 40, wherein the aqueous flooding fluid further comprises starch, guar gum, sodium alginate, gum arabic or methyl cellulose.
